(19) United States
(12) Patent Application Publication
(10) Pub. No.: US 2008/0104232 A1
(43) Pub. Date: May 1, 2008

(54) System And Method For Preventing Unauthorized Bridging To A Computer Network

(76) Inventors: Haim Engler, Maale Adumim (IL); Drew Tick, Jerusalem (IL)

Correspondence Address: KAUTH , POMEROY , PECK & BAILEY ,LLP, P.O. BOX 19152, IRVINE, CA, 92623, US

(21) Appl. No.: 11/795,360

(22) PCT Filed: Jan. 10, 2006
(86) PCT No.: PCT/IL06/00029

§ 371 Date: Jul. 12, 2007

Related U.S. Application Data
(60) Provisional application No. 60/643,343, filed on Jan. 12, 2005.

(51) Int. Cl. G06F 15/16

(52) U.S. Cl. 709/224; 709/203

(57) ABSTRACT

The invention provides a system and method for enhancing the security of a computer network by automatically preventing unauthorized bridging to the network. In several embodiments, software operative on the network allows activation of only a single communications adapter while inactivating all other communications adapters installed on each computer authorized to access the network.

### FIELD OF THE INVENTION

This invention relates generally to the field of data security in computer networks. More particularly, the invention provides a system and method for safeguarding the security of data within a computer network by preventing unauthorized bridging to the network via one or more of the multiple communications adapters typically installed in the computing devices authorized to connect to the network.

### BACKGROUND OF THE INVENTION

Connecting computers through a communications network has become a necessity for most businesses, organizations, and even private individuals. Unfortunately, due to this widespread reliance on communications networks, it has become very difficult to maintain the security of the data transmitted over a network or stored on the individual computers active within a network. Such data has become vulnerable to the prying eyes of hackers and others who gain unauthorized access to the network.

As a first line of defense, access to computer networks typically is confined to authorized users who are identified by means of authentication mechanisms such as distinct user names and passwords. With the tremendous growth in use of the Internet, a number of hardware and software solutions have been developed to cope with a host of threats including the spread of computer viruses, unauthorized access to data and interruption of service. Such solutions include anti-virus software, firewalls and virtual private networks (VPNs).

More recently, a new generation of wireless devices based on the IEEE 802.11 (Wi-Fi), IEEE 1394 (FireWire), and Bluetooth®, standards have been introduced which enable greater connectivity from and to computing devices. Unfortunately, the existing solutions such as anti-virus software, firewalls and VPNs are not sufficient to counter the threats to data security inherent in the use of such devices. These solutions can help protect against attacks originating over the Internet. However, attacks via wireless devices usually take place within the local area networks (LANs) themselves to which the devices are connected; since these devices are behind the firewall, the standard solutions do not offer protection.

Almost all computing devices manufactured and sold today include two or more communications adapters, allowing connectivity to a communications network by various means, e.g. by means of an Ethernet cable or by wireless. In some instances, these different types of network communications adapters installed in a single computing device may become connected simultaneously to different networks, thereby forming a communications “bridge” via the computing device. The act of creating this connection is known in the industry as “bridging”. Bridging enables a user connected to one network using one of the adapters to access a disparate network by utilizing another communications adapter on the same computing device, thereby turning that computing device into a bridge. For example, a computing device may have a wired connection to the Internet and a wireless connection to a LAN. In such cases, an authorized LAN user may establish a wireless connection to the computing device and use it as a bridge to access the Internet.

The possibility of bridging between networks by means of the multiple communications adapters found on most of today's computing devices makes computer networks highly vulnerable to breaches in security. In a typical attack scenario, an authorized user is accessing a LAN via a wired Ethernet connection. If the same device also has an active wireless communications device, such as an IEEE 802.11 wireless adapter, an intruder using his own computing device equipped with a wireless adapter establishes a wireless connection to the authorized computing device and uses it as an entry point/bridge to gain unauthorized access to the LAN. Users of certain operating systems may be particularly vulnerable to such an attack since their network setup wizards automatically create a bridge between the wired and wireless communications adapters.

The present invention provides a solution to this problem by providing a system and method for automatically ensuring that unauthorized bridging to a network via the multiple communications adapters installed in most computers cannot occur.

### PRIOR ART

The focus of much of the prior art that deals with multiple communications adapters is diametrically opposite to that of the present invention. Most references disregard the security threat inherent in the simultaneous use of such adapters and offer solutions that enhance connectivity by providing for redundancy including allowing the simultaneous use of the adapters or the ability to switch from one adapter to another during a single network communications session. See, for example: U.S. Pat. No. 6,763,479; U.S. Pat. No. 6,732,186; U.S. Pat. No. 6,728,780; U.S. Pat. No. 6,314,525; U.S. Pat. No. 5,909,549.

Other references, in particular those dealing with mobile devices such as laptop computers and personal digital assistants (PDAs) provide solutions to the problem of conserving power consumption. These include altering the operating mode of a peripheral device, possibly including network communications adapters, by putting them into idle mode, sleep mode or temporarily disabling the device. See, for example: U.S. Pat. No. 6,584,573; U.S. Pat. No. 6,457,069; U.S. Pat. No. 6,393,474. However, these devices may receive a wake-up call and become active again, allowing for the simultaneous activation of more than one communications adapter.

Additional references describe scanning for active communications links. See, for example: U.S. Pat. No. 6,453,345; U.S. Pat. No. 6,108,786; U.S. Pat. No. 5,701,411. However, their purpose is to monitor and filter network communications to evaluate network attacks, internal and external security breaches, network problems, and the like, and not to prevent unauthorized bridging via multiple communications adapters which are active simultaneously.

### SUMMARY OF THE INVENTION

Embodiments of the invention enhance the security of a computer network by preventing unauthorized bridges to the network. In a number of embodiments, a client connects to the server and the client is configured so that a connection is achieved using only a single communications adapter and all other communications adapters are disabled. In several embodiments, a connection is achieved using a specified communications adapter provided that the client disables one or more other specified communications adapters. One embodiment of the invention includes at least one server under the control of a network administrator and at least one client for use by an authorized user. In addition, the at least one client includes a multiplicity of communication adapters, a software-based system for enhancing the security of the network by automatically preventing unauthorized bridging to the network via one or more of the multiplicity of communication adapters. A Remote Adapter Logic Control module is also included on the client and a Traffic Monitoring Module, an Adapter Control Module, and a Life Check Module are also included on the client. In addition, for each communications session on the client, the Traffic Monitoring Module, upon initiation by the Remote Adapter Logic Control module, scans the multiplicity of communication adapters for communications activity, the Adapter Control Module selectively allows only a single communications adapter to be active during the current communications session, and the Life Check Module monitors the status of the communications session to ascertain when the current communications session has concluded.

In a further embodiment, the multiplicity of communications adapters includes at least two communication adapters selected from the group including a wired Ethernet network interface adapter, a wireless Ethernet network interface adapter, a wireless cellular network interface adapter, a Bluetooth® wireless interface adapter, an IEEE 1394 (FireWire) interface adapter, a wireless infrared interface adapter (IrDA), a serial interface adapter, an optical fiber adapter (FDDI), a Universal Serial Bus (USB) adapter, a fax/modem, and a mass storage device.

In another embodiment, the active communications adapter is automatically selected according to logic defined by the Remote Adapter Logic Control module.

In a still further embodiment, the logic comprises a priority list of communication adapters determined by a network administrator.

In still another embodiment, an alternate communications adapter may become active only after the current communications session has been terminated and a new communications session has been initiated.

In a yet further embodiment, the alternate communications adapter becomes active only after the client has been shut-down and re-booted.

In yet another embodiment, the alternate communications adapter becomes active only after the user has provided authorized security identification.

In a further embodiment again, the client is any of a desktop personal computer (PC), a personal digital assistant (PDA), a PC with an infrared connection to a PDA, a cellular telephone, a credit card reader, and a wireless terminal.

An embodiment of the method of the invention includes activating, under the control of the network supervisor, during each communications session on a client including a multiplicity of communications adapters, only a single communications adapter for use by the client while inactivating one or more of the alternate communications adapters, thereby preventing unauthorized bridging to a network via the one or more alternate communication adapters.

In a further embodiment of the method of the invention the multiplicity of communications adapters includes at least two communication adapters selected from the group of a wired Ethernet network interface adapter, a wireless Ethernet network interface adapter, a wireless cellular network interface adapter, a Bluetooth® wireless interface adapter, an IEEE 1394 (FireWire) interface adapter, a wireless infrared interface adapter (IrDA), a serial interface adapter, an optical fiber adapter (FDDI), a Universal Serial Bus (USB) adapter, a fax/modem, and a mass storage device.

In another embodiment of the method of the invention, the active communications adapter is automatically selected based upon logic residing on the server.

In a still further embodiment of the method of the invention, the logic comprises a priority list of communication adapters determined by a network administrator.

In still another embodiment, an alternate communications adapter may become active only after the current communications session has been terminated and a new communications session has been initiated.

In a yet further embodiment, the alternate communications adapter becomes active only after the client has been shut-down and re-booted.

In yet another embodiment, the alternate communications adapter becomes active only after the user has provided authorized security identification.

In a further embodiment again, the priority list is determined based upon one or more factors selected from the group comprising user parameters, type of adapter, time of transmission, amount of data to be transmitted, and the nature of the data to be transmitted.

In another embodiment again, a second communications adapter is activated during a single communications session.

In a further additional embodiment, the second communications adapter is selected from the group comprising a Universal Serial Bus (USB) adapter, a fax/modem, and a mass storage device.

In another additional embodiment, the intelligence for selecting the active communications adapter and for inactivating the alternate communications adapters resides on the client.

In another further embodiment, feedback is provided from the client to the server, to enable a network administrator to assess network security and alter the priority list.

### BRIEF DESCRIPTION OF THE DRAWINGS

FIG. 1 is an illustrative diagram showing a typical computing device (a laptop computer) having multiple communications adapters each of which enables communication to and from the computing device by a different device and by different means.

FIG. 2 is a block diagram showing the functional relationship in accordance with the present invention among the Remote Adapter Logic Control module, the local Adapter Control module, the Traffic Monitoring module and the Life Check module.

FIG. 3 is a process flow chart illustrating the management operations of the Remote Adapter Logic Control module in accordance with the present invention.

FIG. 4 is a flow chart illustrating the operation of the Adapter Control Decision module in accordance with the present invention.

FIG. 5 is a process flow chart illustrating the operation of the Life Check module, in accordance with the present invention.

### DESCRIPTION OF THE INVENTION

The present invention provides a system and method for enhancing the security of a communications network by automatically preventing bridging to the network by an unauthorized user utilizing one or more of the multiple communications adapters typically installed on most computing devices.

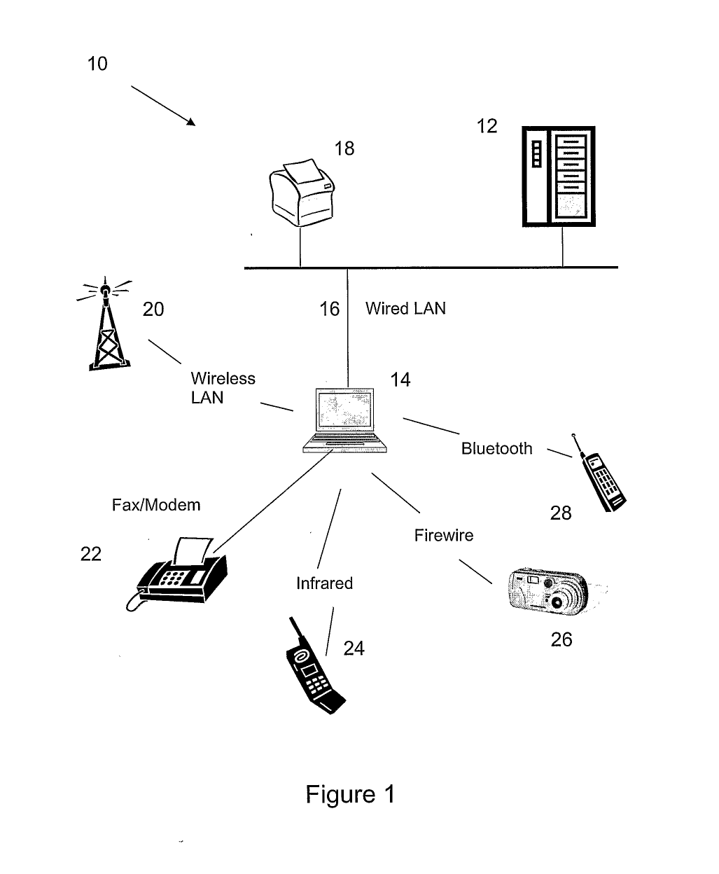

An illustration of a typical communications network 10 for which the present invention is intended is presented in FIG. 1. The network 10 includes at least one server 12 and at least one client 14. It can be appreciated that most communications networks comprise a large number of clients, and that only a single device 14 is illustrated in FIG. 1 for reasons of simplicity (the term “client” as used herein may refer either to the computing device itself or to software installed on the device by means of which communication is established and maintained with the server). The server 12 may be any type of server known in the art, such as an xSeries server manufactured by IBM corporation of Armonk, N.Y., and may be located anywhere. The client 14 may be any type of computing device such as a laptop (as illustrated), a desktop personal computer (PC), a personal digital assistant (PDA), a cellular telephone, and the like.

In the illustration of FIG. 1, the client 14 is connected to the server 12 via a wired local area network (LAN) connection 16. Such a connection is enabled by the presence on the client 14 of a wired local area network communications adapter (not shown), typically an Ethernet card, as is known in the art, which enables wired connection between a computing device and a wired network. By means of the wired connection 16, the client 14 is also connected to one or more peripheral devices within the network such as the printer 18.

Installed on the client 14 are any of a number of additional communications adapters (not shown) which enable communication to and from the client 14 by means other than the Ethernet card. In the illustration of FIG. 1, these include the following: (a) a wireless LAN card (such as a 80211 b/g/n card), for wireless connection to a wireless network 20; (b) a modem, for connection to and from a telephone or fax machine 22; (c) an infrared card (such as that manufactured by Intel Corporation of Santa Clara, Calif.), for infrared communication with a cellular telephone 24; (d) a FireWire card (such as that manufactured by Texas Instruments Incorporated of Dallas, Tex.) for communication with a digital camera 26; and (e) a Bluetooth® card (such as that manufactured by Nokia of Finland), for communication with any device equipped for Bluetooth® communication, such as a cell phone 28. Many other modes of communication with the client 14 are possible, each requiring its own communications adapter. One of the most common on the newer computing devices is a Universal Serial Bus (USB) port, enabling communication with many different types of external devices, such as a “disk-on-key”. Also shown in FIG. 1 is a line connection between the client 14 and a fax/modem 22.

An authorized user of the network 10 typically will be allowed access to the network only after successfully identifying himself or herself by means of a unique user name and password. However, once connected to the network 10, the client 14 poses a serious risk to the security of the data contained within and transmitted over the network. This is because a hacker, or any unauthorized user, may easily gain access to the client 14 via one or more of the communications adapters installed on the client 14 as described above. For example, an unauthorized user utilizing a wireless network 20 may access the client 14 via the wireless communications adapter installed on the client 14. Once this has been accomplished, the unauthorized user can use the device 14 as a “bridge” to unlawfully gain access to the network 10 to which the client is lawfully connected via the wired LAN adapter. Any of the other communications adapters could be used in a similar fashion to gain unauthorized access to the network 10 and/or to read and/or copy data from within the network.

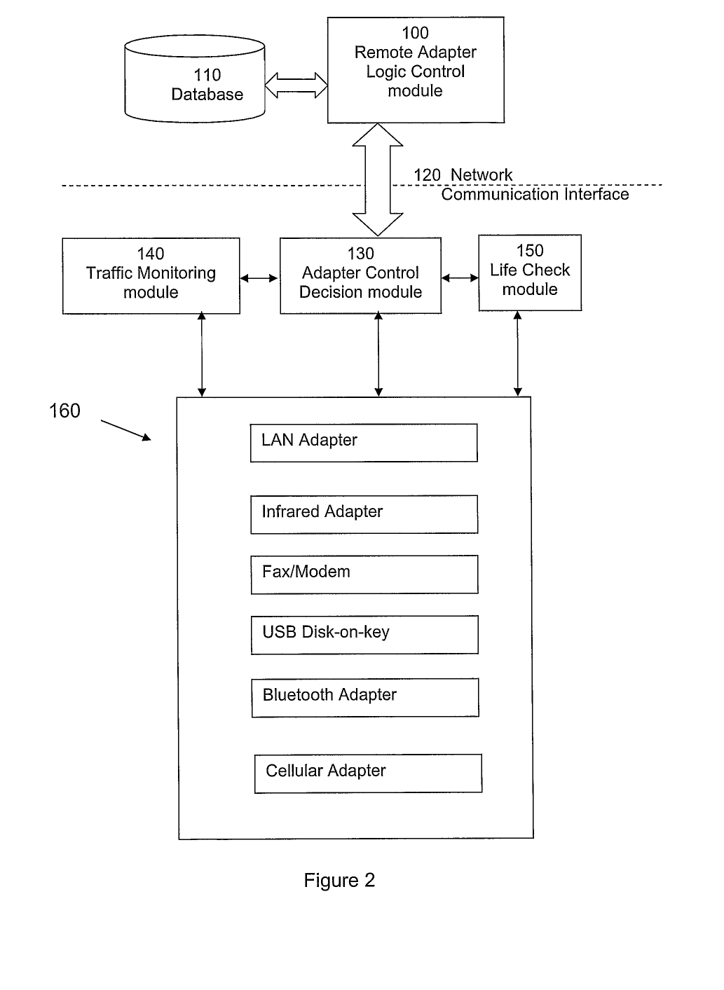

FIG. 2 presents schematically the system and method of the present invention for preventing the type of unauthorized access to the network described above. In a number of embodiments, the system and method is software based, and is operable within the context of any communications network, regardless of operating system or platform. As can be seen from FIG. 2, this system comprises a Remote Adapter Logic Control module 100, which typically resides on a server or on any other dedicated network machine, and an Adapter Control Decision module 130, a Traffic Monitoring module 140 and a Life Check module 150, each of which typically resides on a client. In some embodiments of the present invention, all of the modules may reside on a client. In other embodiments, they may reside on a server or on another device in communication with a server.

The Remote Adapter Logic Controller 100 communicates with a database 110 and, via a network communications interface 120, with the Adapter Control Decision module 130, in a manner more fully described below. The Adapter Control Decision module 130 communicates in turn with each of the Traffic Monitoring module 140 and the Life Check module 150, and each of the modules communicates with all of the communications adapters (collectively labeled 160) installed on a client.

In operation, the Remote Adapter Logic Control module 100 initiates a request on an Adapter Control Decision module 130, via a network communication interface 120, to start various activities, including scanning for available adapters, monitoring adapter activity status or traffic, and then disabling and enabling the adapters as more fully described below. The Traffic Monitoring Module 140 scans for specific packet information, and the Life Check Module 150 detects the activity status of the adapters. The Adapter Control Decision Module 130, in turn, communicates relevant information via the network communication interface 120 to the Remote Adapter Logic Control module 100.

The Remote Adapter Logic Control module 100 may store and read information from a local database 110 which may also be read/updated by a network administrator. A network administrator is typically a user with higher access privileges than other users of the network.

In some embodiments, a Remote Adapter Logic Control module 100 may reside on client 14 and send information to and/or retrieve information from the database 110. In other embodiments, the database 110 may also reside on a client, making the client fully independent.

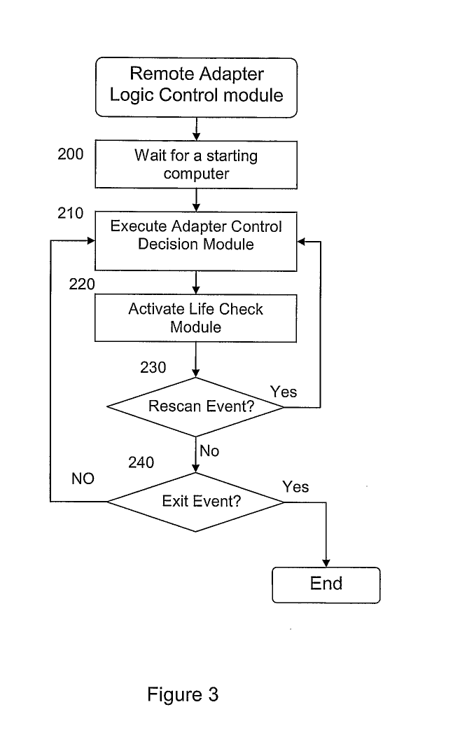

Reference is now made to FIG. 3, which is a flow chart showing a process for restricting a client connected to a server to have a single active communications adapter in accordance with an embodiment of the invention. The process includes waiting (200) for a signal to be received by a server indicating that a client has requested authorization to access the network, and activating (210) an Adapter Control Decision module. A Life Check module is also activated (220). In the event Life Check module returns a rescan status, the process loops back to activating (210) the Adapter Control Decision module. Alternatively, the process exits upon an exit status. The process also loops back to activating (210) the Adapter Control Decision module in the event that the Life Check module returns any other status.

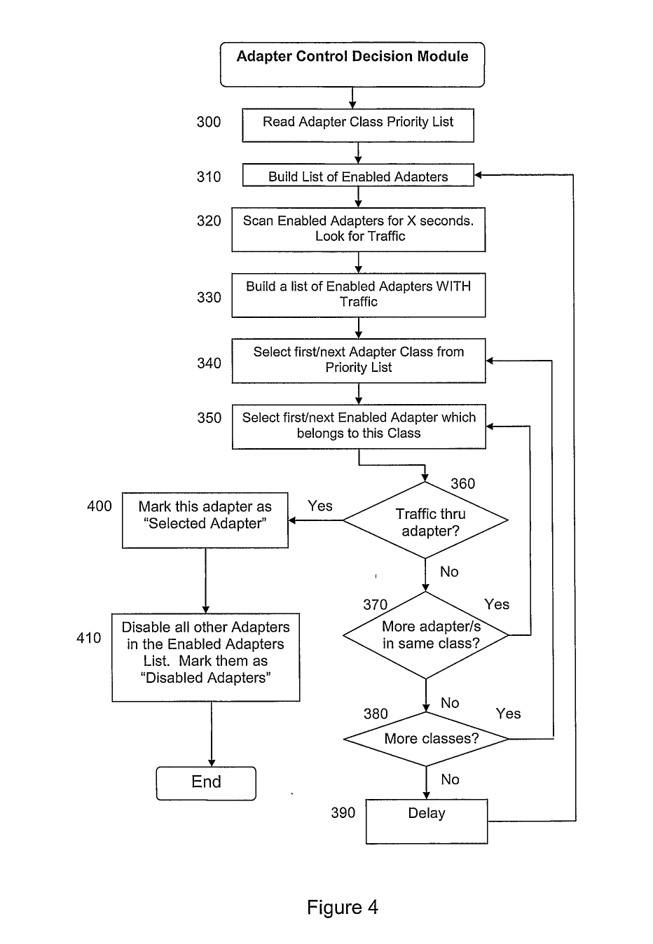

Reference is now made to FIG. 4, which is a flow chart showing a process performed by an activated Adapter Control Decision module in accordance with an embodiment of the invention. The process includes retrieving (300) from a database a set of parameters, including an Adapter Class Priority List. The Adapter Class Priority List is a list of classes of communications adapters that can be available on client machines. Such a list may contain, for example, all of the following: wired LAN, wireless LAN (WLAN), Fax/Modem, IrDA, 1394, USB Disk-on-key, Bluetooth, FDDI etc. In many embodiments, each item in the list is assigned a unique priority value that determines its priority relative to other communications adapters. For example, in the above list, the class of wired LAN adapters may have precedence over all the other classes of adapters. As will be explained below, the priority value will eventually be utilized to determine which adapter will be selected for activation, while others will be disabled. In many embodiments, all other communications adapters are disabled. In several embodiments, other communications adapters that receive network traffic are disabled. An Adapter Class Priority List can be determined as a system-wide default by the network administrator, and may be updated from time to time or dynamically as needed. In several embodiments of the invention, the Priority List may also be updated by an authorized user, subject to authorization criteria set by the network administrator.

An Adapter Control Decision module located on a specific client machine that has accessed the network is queried (310) by the Adapter Control Decision module in order to build a list of all adapters enabled on that client. The Traffic Monitoring module of the client machine is instructed (320) to scan, for a pre-defined period of time, for traffic on each of the enabled adapters. “Traffic” for this purpose typically will be any network packets going through the adapter; however, it may also include the mere physical presence of a plug indicating that an external device has been attached to an adapter, even if there is no actual traffic going through it (for example, a disk-on-key plugged in to a USB port). The scanning period may be set by the network administrator, and typically will be between a few milliseconds and a few seconds.

A list of enabled adapters which have had some “traffic” during the scan is then built (330). The adapter class with the highest priority from the adapter class Priority List is then selected (340) and the first enabled adapter on the client belonging to that class is also selected (350). A determination (360) is made as to whether the selected adapter received any network traffic. If the selected adapter had traffic, the selected adapter is marked as “selected” and enabled (400). All other adapters are marked as “disabled” and disabled (410). It will be appreciated that there are many ways to disable and enable the adapters utilizing system calls to the specific operating system on the computing device on which the software is installed.

If there was no traffic through the first selected adapter, the next adapter belonging to the same class is selected (370) and the process of determining (350) whether the next adapter had traffic repeats.

If there are no additional adapters belonging to the selected class, the class of adapters next highest on the Priority List is selected (380) and the process of selecting (350) the first enabled adapter on the client belonging to that class is repeated.

After a pre-defined period of delay (390), the Adapter Control Decision module is queried (310) again and the process repeats. This will occur if there are both no additional classes and no specific adapter to select, indicating that all the relevant adapters in the client are not functioning. The delay is provided to ensure that communications adapters are functioning properly.

It will be appreciated that as a result of these procedures, only a single communications adapter will be enabled and active on the client during a communications session; all the other adapters will be disabled, thereby preventing the use of one or more of these adapters by an unauthorized source to access these adapters and through them to bridge to the network. In other embodiments, only those communications adapters that are determined to be receiving network traffic are disabled.

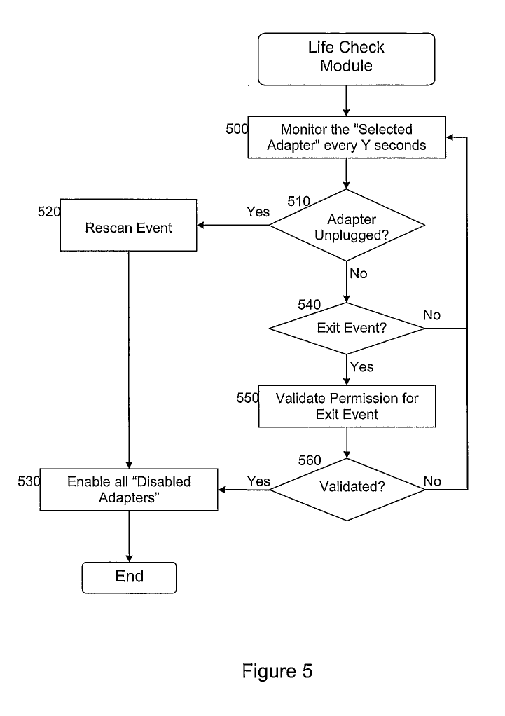

Reference is now made to FIG. 5 which is a flow diagram illustrating a process performed by a Life Check module in accordance with an embodiment of the invention. At pre-determined intervals, typically between five and sixty seconds, the selected adapter is checked (500) to verify that the adapter is still functioning. A determination (510) is made as to whether the selected adapter has ceased functioning. If the selected adapter has ceased functioning, a rescan status is returned (520) and all disabled adapters are enabled (530). If the selected adapter is functioning, a determination (540) is made to check if a user has requested to exit. If the user has requested to exit, the process restarts (500). If the user permission to exit is validated, all disabled adapters are enabled (530) and the process terminates. If the user permission to exit is not validated, the process restarts 500.

It can be appreciated that the software typically will comprise additional modules and procedures not described above. For example, a Life Check module in accordance with several embodiments of the invention includes a procedure enabling the user to request permission to disable a currently active adapter, and to enable another adapter in its stead, subject to the permission of the network administrator and only after the user has provided authorized security identification. Under certain circumstances, the activation of another adapter will only be allowed after the computing device has been rebooted. In unusual circumstances, the software may also allow the enabling of more than a single adapter during the current communications session. In a number of embodiments, trusted adapters that are unlikely to pose a threat such as a CD ROM drive or a USB disk-on-key, are enabled in addition to an adapter configured for communication with a remote device. In other embodiments, the Adapter Class Priority list specifies whether an adapter is enabled or disabled and the Adapter Class Priority list can be modified by a system administrator and/or an appropriately authenticated user.

It can also appreciated that the detailed description above illustrates only certain embodiments of the present invention. However, it in no way is intended to limit the scope of the invention, as set forth in the following claims.

1. A computer network, comprising:
at least one server; and
at least one client;
wherein the at least one client comprises a multiplicity of communications adapters;
wherein the client is configured to communicate with the server using at least one of the multiplicity of communications adapters;
wherein the server is configured to initiate a
communications session with the client;
wherein the client is configured to scan the multiplicity of communications adapters for communications activity;
wherein the client is configured to selectively allow only a single communications adapter to be active during a communications session; and
wherein the client is configured to monitor the status of the communications session to ascertain when the communications session has concluded.

2. The network according to claim 1, wherein the multiplicity of communications adapters comprises at least two communication adapters selected from the group comprising: a wired Ethernet network interface adapter, a wireless Ethernet network interface adapter, a wireless cellular network interface adapter, a Bluetooth® wireless interface adapter, an IEEE 1394 (FireWire) interface adapter, a wireless infrared interface adapter (IrDA), a serial interface adapter, an optical fiber adapter (FDDI), a Universal Serial Bus (USB) adapter, a fax/modem, and a mass storage device.

3. The network according to claim 1, wherein the active communications adapter is automatically selected according to logic defined by the server.

4. The network according to claim 3, wherein the logic defined by the server comprises a priority list of communication adapters determined by a network administrator.

5. The network according to claim 1, wherein the client is configured so that an inactive communications adapter may become active only after a communications session has been terminated and a new communications session has been initiated.

6. The network according to claim 4, wherein the client is configured so that an inactive communications adapter becomes active only after the client has been shut-down and re-booted.

7. The network according to claim 5, wherein the client is configured so that the inactive communications adapter becomes active only after the user has provided authorized security identification.

8. The network according to claim 1, wherein the client is desktop personal computer (PC), a personal digital assistant (PDA), a PC with an infrared connection to a PDA, a cellular telephone, a credit card reader, or a wireless terminal.

9. A method for conducting a communications session between a server and a client having a plurality of communications adapters, comprising:
initiating a communications session between the server and the client;
monitoring traffic on the plurality of communications adapters;
activating one of the plurality of communications adapters for use during the communications sessions; and
inactivating one or more of the plurality of communications adapters.

10. The method according to claim 9, wherein the multiplicity of communications adapters comprises at least two communication adapters selected from the group comprising: a wired Ethernet network interface adapter, a wireless Ethernet network interface adapter, a wireless cellular network interface adapter, a Bluetooth® wireless interface adapter, an IEEE 1394 (FireWire) interface adapter, a wireless infrared interface adapter (IrDA), a serial interface adapter, an optical fiber adapter (FDDI), a Universal Serial Bus (USB) adapter, a fax/modem, and a mass storage device.

11. The method according to claim 9, further comprising:
storing a priority list on the server that enables the automatic selection of a communications adapter to activate; and
providing the client with the priority list.

12. The method according to claim 11 wherein the priority list of communication adapters is determined by a network administrator.

13. The method according to claim 9, further comprising activating an alternate communications adapter when the communications session is terminated and a new communications session initiated.

14. The method according to claim 13, wherein the alternate communications adapter becomes active when the client has been shut-down and re-booted.

15. The method according to claim 9, further comprising activating an alternate communications adapter when the user has provided authorized security identification.

16. The method according to claim 12, wherein the priority list is determined based upon one or more factors selected from the group comprising user parameters, type of adapter, time of transmission, amount of data to be transmitted, and the nature of the data to be transmitted.

17. The method according to claim 9, further comprising activating a second communications adapter during the communications session.

18. The method according to claim 17, wherein the second communications adapter is selected from the group comprising a Universal Serial Bus (USB) adapter, a fax/modem, and a mass storage device.

19. The method according to claim 9, further comprising:
selecting the communications adapter to activate and the communications adapters to inactivate;
wherein the client selects the active communications adapter and the inactive communications adapters.

20. The method according to claim 9, further comprising:
providing feedback from the client to the server;
assessing network security; and
altering the priority list.
